(19) United States
(12) Patent Application Publication
(10) Pub. No.: US 2010/0139858 A1
(43) Pub. Date: Jun. 10, 2010

(54) MASKING ARTICLE COMPRISING SKINNED FOAM

(75) Inventors: Malcolm F. Douglas, Swansea (GB); Martyn V. Hagedorn, Swansea (GB); Philip S. Hill, Leicestershire (GB); Stephen J. Hollowell, Northampton (GB); Gary N. Brotherton, Warwickshire (GB); Colin D. Sinclair, Coventry (GB)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, St. Paul, MN (US)

(21) Appl. No.: 12/598,302

(22) PCT Filed: Jun. 11, 2008
(86) PCT No.: PCT/US2008/066476

§ 371 Date: Oct. 30, 2009

(30) Foreign Application Priority Data
Jun. 11, 2007 (GB) 0711109.9

(51) Int. Cl. B32B 37/12; C08J 9/34; B32B 1/00; B32B 7/12

(52) U.S. Cl. 156/290; 521/51; 428/174; 428/317.3

(57) ABSTRACT

An elongate masking article (1) that can be removably-attached to a vehicle for masking a surface to be painted, the article being formed from polymeric foam which, on the external surface of the article, or at least a lengthwise-extending part thereof, comprises an integral skin (7). The position of the integral skin on the article is such that, when the article is attached to a vehicle for masking a surface to be painted, at least a part of the skin will face generally towards the direction from which paint will be applied.

### FIELD OF THE INVENTION

This invention relates to masking articles of the kind that can be removably-attached to a vehicle for masking a surface to be painted. The invention relates more especially, but not exclusively, to masking articles that are suitable for masking a gap between two relatively-movable parts of a vehicle, to prevent paint or other surface treatment material that is being applied to the vehicle penetrating through the gap into the interior of the vehicle. The gap is typically associated with an opening in the vehicle, for example a door, boot or bonnet opening, and the surface treatment material is typically applied using some form of liquid-spraying apparatus.

### BACKGROUND

Masking materials are used to cover one area of an object while paint, or some other surface treatment material, is applied to an adjacent area. In the case of vehicles, such as cars, vans, lorries or caravans, masking materials are used most extensively (although not exclusively) when exterior surfaces of a vehicle are being painted, or otherwise treated, during repair or renovation.

In the following, for simplicity, the term “paint” will be used to include other similar surface treatment materials that are applied to the exterior surfaces of vehicles including, for example primers, anti-rust treatments, lacquers, and the term “painting” should be interpreted accordingly.

One particular situation in which some form of masking article is required is when spray painting around a gap between relatively-movable parts of a vehicle, such as the gap between a door and the associated surrounds. In that case, it is necessary to ensure that the paint does not get into the interior of the vehicle, and it is also desirable to ensure that the paint does not accumulate in the vicinity of the gap to give an uneven finish. Various masking articles have previously been proposed to address these difficulties.

For example, it has been proposed to use a masking article in the form of an elongate foam tape to fill the gap between a movable part of the vehicle such as a door, hood/bonnet or trunk/boot and an adjacent part of the vehicle. The foam tape may have a longitudinally-extending stripe of pressure sensitive adhesive enabling the tape to be secured in the required position prior to painting and subsequently removed after painting. EP-A-0 384 626 describes a foam tape of that type having a pair of welded seams along its length such that the article has an oval or circular cross-section: the tape allows surfaces in the vicinity of a gap to be spray painted in such a way that the edge of the paintwork blends into the adjacent unpainted regions and unsightly paint ridges are avoided.

Other masking articles for use in gaps in vehicles are described in U.S. Pat. No. 5,260,097 (Silvestre); U.S. Pat. No. 5,885,395 (Western); U.S. Pat. No. 6,630,227 B1 (Himmelsbach et al.); U.S. Pat. No. 6,797,361 B1 (Bouic); WO 99/12654 (Jevons); and WO 02/068556 and WO 03/020438 (Jevtec Limited).

Masking articles are also used to mask swage lines on vehicles (i.e. lines where there is a change in contour in the vehicle bodywork) in preparation for spray painting. In that case, the masking material is required to ensure that the edge of the surface area that is being painted will merge smoothly, along the swage line, with the surface area that is being protected. Additionally, masking articles are used for blending newly applied paint on regions of a vehicle body surface into regions having the original paint. For example, where a small repair has been done on a panel, it may be unnecessary to respray the whole panel.

Although some foam masking tapes have proved to be extremely effective for masking gaps and/or swage lines in vehicles and also very convenient to use, there is a continuing desire to improve the finish of the edge of the new paintwork so that the result resembles as closely as possible the finish on a newly-manufactured vehicle.

The present invention is concerned with the provision of a masking article suitable for use in masking a surface of a vehicle in preparation for painting, which article enables a good quality finish to be obtained at the edge of the new paintwork. The invention is concerned especially with the provision of a masking article suitable for masking swage lines and/or for masking gaps between two relatively-movable parts of a vehicle.

### SUMMARY OF THE INVENTION

The present invention provides an elongate masking article that can be removably-attached to a vehicle for masking a surface to be painted, the article being formed from polymeric foam which, on the external surface of the article, or at least a lengthwise-extending part thereof, comprises an integral skin.

As used herein, the term “integral skin” means a distinct, higher density layer that is formed from the same material as the foam and is an integral part thereof.

It has been found that the presence of the skin in the vicinity of the edge of the surface that is being painted enables an improvement to be achieved in the quality of the paint edge. Consequently, the position of the integral skin on the article is preferably such that, when the article is attached to a vehicle for masking a surface to be painted, at least a part of the skin will face generally towards the direction from which paint will be applied.

Advantageously, the portion of the external surface of the article on which the said part of the skin is located is curved, at least when the article is attached to a vehicle for masking a surface to be painted. The curvature of the surface assists in preventing the build-up of paint at the edge of the surface that is being painted.

In some embodiments, in which the article comprises a curved external surface maintained by at least one welded seam that extends along the length of the article, the construction of the article facilitates manufacture on a large scale. Manufacture is further facilitated if the polymeric foam is of a type in which welded seams can be formed through the application of pressure without the input of heat.

A masking article in accordance with the invention may comprise two layers of polymer foam that are arranged face-to-face and joined to one another along their edges by the welded seams. Articles of that type can be provided that are versatile enough to be used in a wide variety of gaps in vehicles, in terms of dimensions and shapes.

Any suitable means may be provided for removably-attaching a masking article of the invention to a vehicle. Advantageously, a pressure-sensitive adhesive is provided on the external surface of the article, facilitating both manufacture and use of the article.

### BRIEF DESCRIPTION OF THE DRAWINGS

By way of example, embodiments of the invention will now be described with reference to the accompanying drawings, in which:

FIG. 1 is a perspective view of a masking article in accordance with the invention;

FIG. 2 is a diagrammatic transverse cross-section of the article of FIG. 1;

FIGS. 3A and 3B show schematic cross sections of the gap between the rear door and the adjacent frame of a vehicle, with the masking article of FIG. 1 in place, in the door ajar and door closed positions respectively;

FIG. 4 is a diagram illustrating a process for forming an integral skin on a web of foam material;

FIG. 5 is a diagram illustrating a process for making an array of the masking articles of FIG. 1;

FIG. 6 is a diagrammatic transverse cross-section of skinned foam material produced by the process illustrated in FIG. 4;

FIG. 7 is a diagrammatic perspective view of an array of masking articles made by the processes of FIGS. 4 and 5;

FIG. 8 is a diagrammatic transverse cross-section of another masking article in accordance with the invention;

FIG. 9 is a perspective view of another masking article in accordance with the invention;

FIG. 10 is a diagrammatic transverse cross-section of the article of FIG. 9;

FIGS. 11A and 11B are similar to FIGS. 3A and 3B but using the masking article of FIG. 9;

FIG. 12 is a diagram illustrating a process for making an array of the masking articles of FIG. 9;

FIG. 13 is a diagrammatic perspective view of an array of masking articles made by the process of FIG. 12; and

FIG. 14 is a diagrammatic transverse cross-section of another masking article in accordance with the invention.

### DETAILED DESCRIPTION

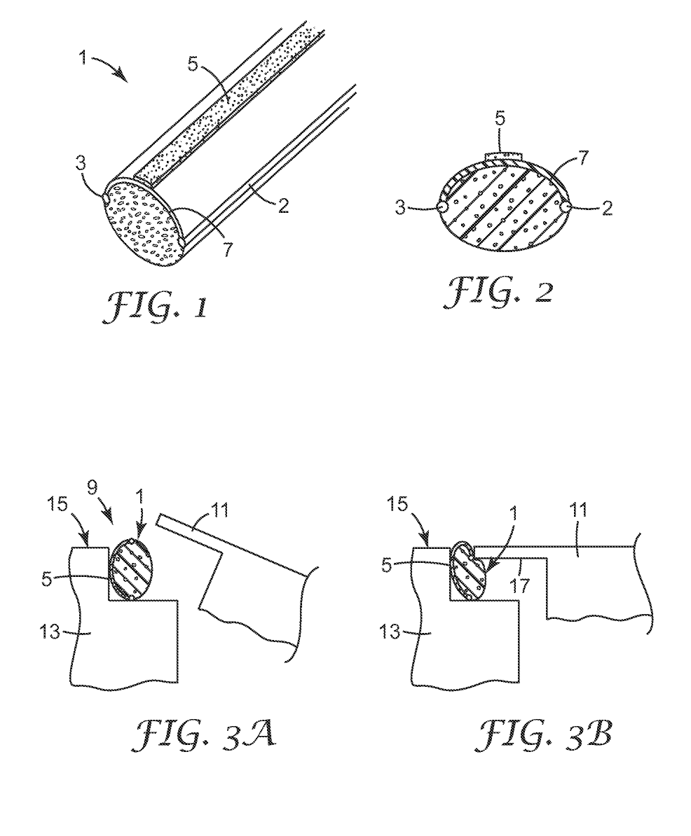

FIGS. 1 and 2 show, very diagrammatically, an elongate article in the form of a flexible tape 1 suitable for masking a gap between two relatively-movable parts of a vehicle. The tape 1 is formed from a resiliently-compressible foam material and has a generally elliptical cross-section with longitudinally-extending welds 2, 3 on opposite sides of the tape. As described in greater detail below, the welds 2, 3 maintain the configuration of the curved surface of the tape. On one part of the external surface of the tape 1 between the welds 2, 3 is a lengthwise-extending stripe of adhesive 5, positioned mid-way between the welds. The whole of this part of the external surface of the tape 1 between the welds 2, 3 comprises an integral skin 7, described in greater detail below, which gives this surface a smoother texture than the rest of the tape.

The cross-sectional dimensions of the tape 1 depend on its intended use, specifically the nature of the gaps in which it is intended to be used. Those gaps include, for example, the gaps between the doors of a vehicle and the surrounding frame, and the gaps between the bonnet/boot of a vehicle and the surrounding frame, and will vary from one vehicle to another. Typical dimensions for the width of the tape, between the welds 2, 3, are in the range of from 10 to 30 mm. Typical dimensions for the thickness of the tape (i.e. in the orthogonal direction) are in the range of from 10 to 20 mm. Tapes with dimensions outside of those ranges can, of course, be used if appropriate. Foam tapes of the type shown in FIGS. 1 and 2 and with comparable dimensions can also, if required, be produced with circular cross-sections.

FIGS. 3A and 3B illustrate, by way of example, the use of a tape 1 to mask a gap 9 between a door 11 of a vehicle and an adjacent part, indicated at 13, in preparation for spray painting the exterior surfaces of the car during a repair operation. Depending on the nature of the repair operation, the tape 1 may be applied around the whole, or only a part, of the door opening. In the particular case illustrated, the gap 9 is representative of that between the rear door of a car and the adjacent frame, the width of which (when the door is closed) is typically at least 3 mm.

As shown in FIG. 3A, the tape 1 is attached by the adhesive stripe 5 to surface 15 of the frame 13, with the door 11 slightly ajar. The door 11 is then closed (see FIG. 3B), bringing the edge 17 of the door into contact with the tape 1 which fills the gap 9 and thereby masks the latter in preparation for spray-painting of the edge of the door and the adjacent surface 15. Part of the skinned surface 7 of the tape 1 remains exposed in the gap 9 when the door 11 is closed and, as described below, contributes to the production of a desirable “soft edge” on the adjacent surface 15 where the applied paint layer blends into the adjacent untreated area. For optimum results, the tape should be applied to the vehicle so that at least a part of the skinned surface faces generally towards the direction from which paint will be applied or, more specifically, lies in the line of sight of the paint spray.

It has been found that the presence of the skinned surface 7 on the tape 1 results in an improvement in the quality of the paint edge produced on the adjacent surface. More specifically, it is found that the number of paint speckles that appear along the paint edge (which can give the edge a fuzzy appearance) is reduced with consequential benefit to the overall appearance of the re-painted surface. Without wishing to be bound by theory, it is believed that the paint speckles which appear when a conventional foam masking tape is used may be due to the presence of pores on the surface of the foam material due to the cellular nature of the latter, and that the formation of the speckles is inhibited by increasing the smoothness of the surface through the provision of the skin 7.

Foam tapes of the type shown in FIGS. 1 and 2 can also be used to mask swage lines on vehicles (i.e. lines where there is a change in contour in the vehicle bodywork) in preparation for spray painting. In that case also, the presence of the skinned surface 7 enables an improvement to be obtained in the quality of the paint edge, along the swage line, between the area of the vehicle bodywork that is being painted and the adjacent area. Again, for optimum results, the tape should be applied to the vehicle so that at least a part of the skinned surface is adjacent to the paint edge and faces generally towards the direction from which paint will be applied or, more specifically, lies in the line of sight of the paint spray.

Foam materials having an integral skin are well known: indeed, an integral skin of some sort is formed on the exposed surface of polymeric foam during conventional foaming processes and is often removed by a process known as “skiving” before the foam is put to use. Likewise, an integral skin may be formed on foam articles produced by an extrusion process (see, for example, the BACKGROUND section of U.S. Pat. No. 3,869,832 of Gibb). In the case of thermoplastic polymeric foams, it is known that an integral skin can be produced on the foam material in a controlled manner after manufacture by the application of heat and pressure to the foam as described in U.S. Pat. No. 3,123,656 (Rochlin) and U.S. Pat. No. 3,443,007 (Hardy), or by the application of an additional layer as described in U.S. Pat. No. 2,994,110 (Hardy). The “integral skin” is a higher-density layer at the outer surface of the foam material: it is formed from the same material as the foam and is an integral part thereof but is a distinct area (in other words, an abrupt change can be perceived between the average density of the skin and the average density of the foam material beneath the skin) Depending on the process conditions, the outer surface of the skin may still exhibit the presence of pores, although they will be fewer in number than in an “unskinned” surface (i.e. the outer surface of the skin will be more closed, and smoother).

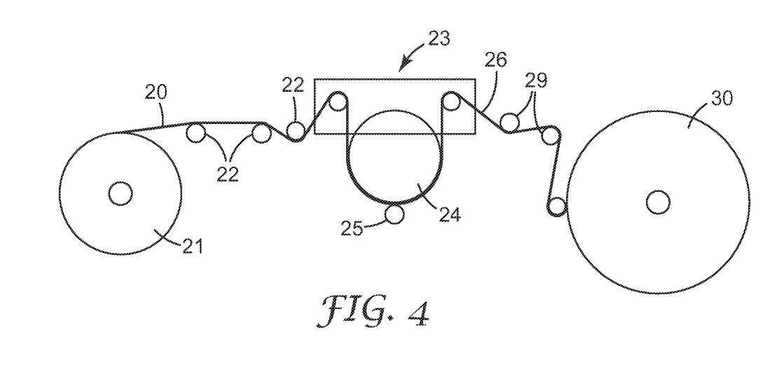

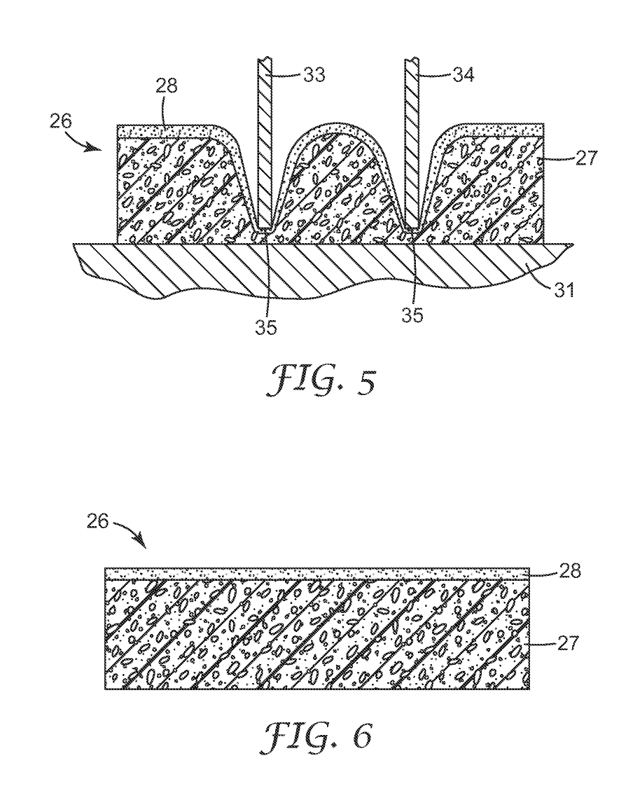

FIG. 4 illustrates the formation of an integral skin in a controlled manner on one surface of a web of thermoplastic polymeric foam material of suitable width, and FIG. 5 shows how a web of that type can be converted into an array of foam tapes.

FIG. 4 shows the web of polymeric foam material 20 being fed from a roll 21, via a series of rollers 22, to a station 23 where an integral skin is formed on the upper surface of the web (as viewed in the drawing). The skin is formed by passing the web around a heated roll 24 and through a nip between the heated roll and a pressure roller 25. The temperature of the heated roll 24 and the pressure exerted by the roller 25 on the web, together with the process speed, are selected to ensure the formation, over the entire surface of the web adjacent the heated roll, of an integral skin having the required thickness and an outer surface with the required degree of smoothness. The skinned web 26 that leaves the station 23 is of reduced thickness and, as illustrated by the cross-sectional view of FIG. 6, comprises a layer 27 of the original foam material with the integral skin 28 on one surface. The skinned web 26 is allowed to cool during its passage, via a series of rollers 29, to a roll 30 on which it is re-wound.

Referring now to FIG. 5, the skinned web 26 from the roll 30 is passed around a score roller 31 (only part of which is shown) with the skin 28 outermost. A set of equispaced rotary knives having blunt edges, of which only two 33, 34 are shown, is mounted on a bearing shaft (not shown) located to one side of the score roller 31 and is resiliently-biased towards the score roller with sufficient force to effect a set of parallel, equispaced welds 35 in the intervening skinned web 26 without actually cutting through the web. This type of weld, which is effected by pressure without the input of heat, has been referred to as a “cold weld” and it will be understood that the process illustrated in FIG. 5 requires the foam material 26 to be of a type that is susceptible to being welded in this manner. This type of foam material has been referred to as “cold weldable” foam.

On the opposite side of the score roller 31, a pressure-sensitive hot melt adhesive (not shown) is applied in a series of parallel stripes from a die (not shown) onto the external surface of the foam layer 27, between and in accurate alignment with, each pair of adjacent welds 35. The web material, which now has the form of an array 36 of parallel foam strips 37 joined to one another by welds 35 as shown in FIG. 7, is taken up and wound into a roll either on itself or on a core. The ends of the foam strips 37 in the array can, if desired, be temporarily secured for packaging purposes by, for example, adhesive tabs (as described in EP-A-0 384 626), elastic ties (as described in WO 2005/110905), or staples. When required, any of the foam strips 37 can be separated for the desired length from the array 36 by tearing along the weld(s) 35 by which it is joined to the adjacent strip(s): the separated foam strip has the form of the foam tape 1 shown in FIG. 1 and can be used, for example as described above with reference to FIGS. 3A and 3B, to mask a gap between two parts of a vehicle.

It will be appreciated that the width of foam tapes produced as described with reference to FIG. 5 can be adjusted by changing the distance between the rotary knives 33, 34, and that the position of the adhesive stripe on each tape can be adjusted by changing the positions of the die orifices relative to the rotary knives.

It will also be understood that the skinned web 26 could, if desired, be fed directly from the station 23 of FIG. 4 to the score roller 31 of FIG. 5, without being wound onto the roll 30. Alternatively, if a web of suitable skinned foam is readily available, the process of FIG. 4 becomes unnecessary and the skinned foam can be fed directly around the score roller 31.

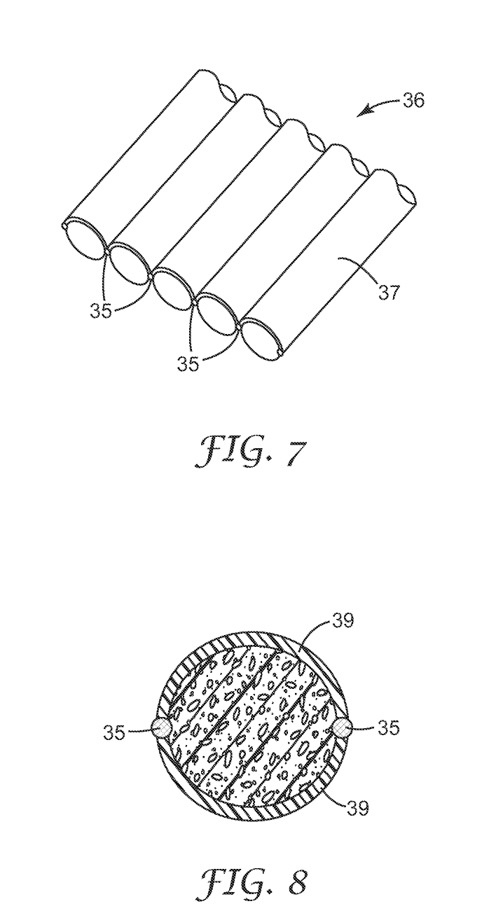

In a modification of the process described above with reference to FIG. 5, the skinned web 26 is passed around the score roller 31 with the skin 28 adjacent the roller, to produce foam tapes in which the adhesive stripe is located on the unskinned part of the tape. In a modification of the process described above with reference to FIG. 4, the skinned web 26 is passed a second time through the station 23 in the reverse orientation so that an integral skin is also formed on the other major face of the web. In this case, the thickness of the web will be reduced twice, and the thickness of the original foam web 20 should be selected to take account of this. The conversion process illustrated in FIG. 5 will then result in an array of foam tapes each of the type shown in FIG. 8, having an integral skin 39 over its entire surface.

A foam material that has been found suitable for making foam tapes as illustrated in FIGS. 1 and 2 or FIG. 8, using processes as described above with reference to FIGS. 4 and 5, is a cold-weldable open cell polyurethane foam having a density of 26 kg/m³ available from Caligen Foams Limited, Broad Oak, Accrington, UK. In a particular example, tapes of the type shown in FIG. 8 were produced from webs of such material 20 (FIG. 4) having thicknesses of 16 mm, 18 mm and 20 mm respectively. Each web was treated as described above to produce, in each case, a web having skin on each side and a thickness of 14 mm. It was noted that the skins produced on the thicker web were more closed than those produced on the thinner web. The foam tapes were produced in widths (i.e. the distance between the welds 35 in FIG. 5) of 14 mm.

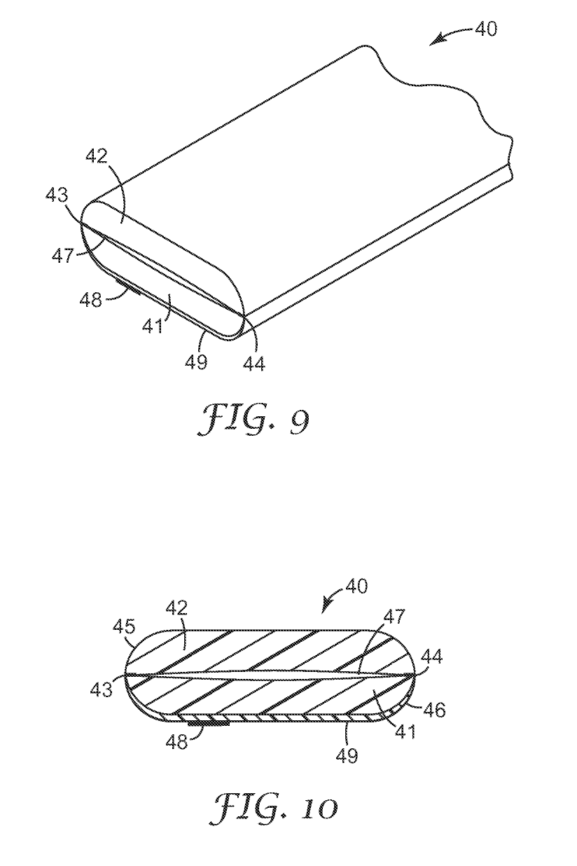

FIG. 9 shows, diagrammatically, another elongate article in the form of a flexible tape 40 suitable for masking a gap between two relatively-movable parts of a vehicle. The tape 40 comprises two elongate layers 41, 42 of resiliently-compressible foam material that are arranged face-to-face and joined together by longitudinally-extending welds 43, 44 on opposite sides of the tape. As shown also in FIG. 10, the cross-section of the tape 40 is elongated in the direction between the welds 43, 44, and is generally rounded at its ends 45, 46 in the vicinity of the welds.

The foam layers 41, 42 and welds 43, 44 enclose, in the centre of the tape 40, a space 47 that is almost closed when the tape is in the rest position because the layers 41, 42 lie comparatively close to each other. An adhesive stripe 48 is provided on the external surface of the tape and extends along the length of the latter. As illustrated, the adhesive stripe 48 is positioned closer to the weld 43 than to the weld 44. The whole of this external surface of the foam layer 41 between the welds 43, 44 comprises an integral skin 49, similar to the skin 7 of the tape 1 described above, which gives this surface a smoother texture than the rest of the tape.

The construction of the tape 40 (including its cross-sectional dimensions and the physical characteristics of the foam material of the layers 41, 42) are such that, when pressure is applied on opposite sides of the tape to move the welds 43, 44 towards one another, the enclosed space 47 will open up and then eventually close again if the welds 43, 44 are moved far enough to be brought into contact with one another.

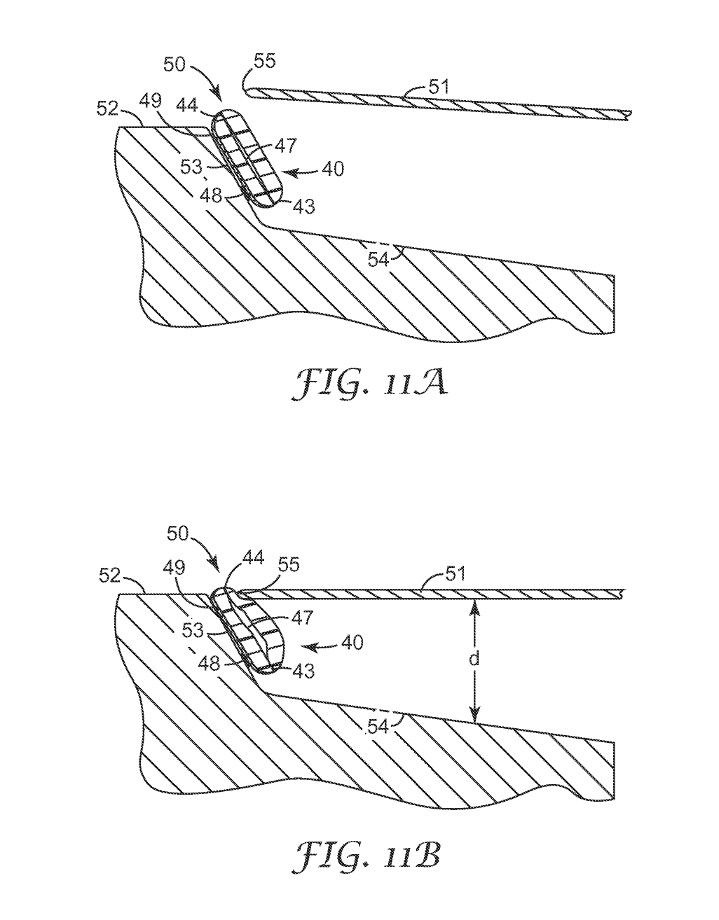

FIGS. 11A and 11B illustrate the use of the tape 40 to mask a gap 50 between a door 51 of a vehicle and an adjacent part, indicated at 52, in preparation for spray painting the exterior surfaces of the car during a repair operation. Depending on the nature of the repair operation, the tape 40 may be applied around the whole, or only a part, of the door opening. In the particular case illustrated, the gap 50 is representative of that between the rear door and the quarter panel of certain modern cars in that the edge of the quarter panel adjacent the door is formed with a dog-leg comprising a surface 53 that extends inwardly from the gap to a wider, landing surface 54 that is more generally parallel to the door 51 when the latter is closed. The landing surface 54 may be spaced apart from the door 51 by a distance d of about 10 cm or more when the door is closed. The width of the gap 50 when the door is closed is typically at least 3 mm in a car and may be as large as 22 mm in a commercial vehicle.

As shown in FIG. 11A, the tape 40 is attached to surface 53 of the dog-leg of the quarter panel, with the door 51 slightly ajar. The tape 40 is positioned with the side defined by the weld 44 located in the vicinity of the gap 50 and the other side, defined by the weld 43, located away from the gap 50 towards the interior of the vehicle. The adhesive stripe 48, which is closer to the weld 43, is thus also located away from the gap 50. The door 51 is then closed, bringing the edge 55 of the door into contact with the non-skinned surface of the masking tape 40 in the vicinity of the weld 44. The pressure exerted by the edge 55 of the door causes the space 47 to open up within the tape 40 while the latter partly folds around within, and fills, the gap 50 thereby masking the latter in preparation for spray-painting of the edge of the door and the adjacent surface 52.

The surface of the tape 40 that remains exposed in the gap 50 when the door 51 is closed enables a desirable “soft edge” to be obtained where the applied paint layer on the surfaces 52, 53 blends into the adjacent untreated surface, and the risk of the adhesive stripe 48 being exposed in the gap 50 and giving rise to a “hard” paint edge is comparatively low. In addition, as described above for the tape 1, it has been found that the presence of the skinned surface 49 on the tape 40 results in an improvement in the quality of that paint edge, through a reduction in the number of paint speckles along the edge. For optimum results, the tape should be applied to the vehicle so that at least a part of the skinned surface faces generally towards the direction from which paint will be applied or, more specifically, lies in the line of sight of the paint spray.

Foam tapes of the type shown in FIGS. 9 and 10, although particularly suitable for masking gaps, can also be used to mask swage lines on vehicles (i.e. lines where there is a change in contour in the vehicle bodywork) in preparation for spray painting. In that case also, the presence of the skinned surface 49 may enable an improvement to be obtained in the quality of the paint edge, along the swage line, between the area of the vehicle bodywork that is being painted and the adjacent area. In this case also, for optimum results, the tape should be applied to the vehicle so that at least a part of the skinned surface faces generally towards the direction from which paint will be applied or, more specifically, lies in the line of sight of the paint spray.

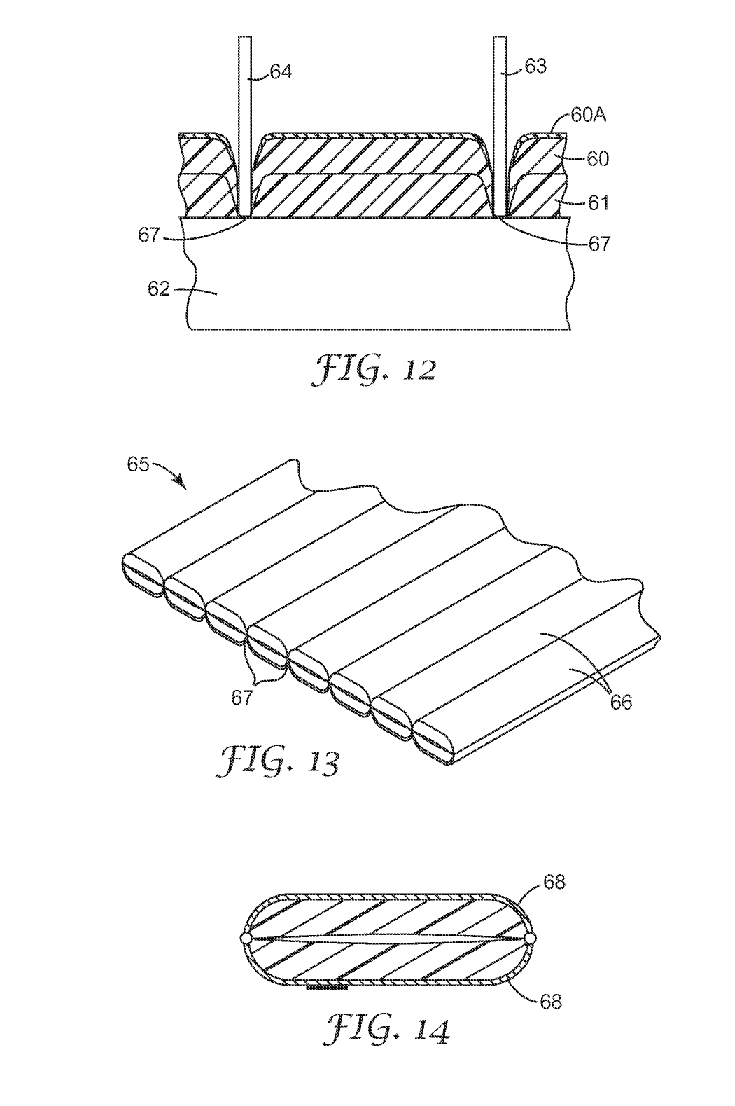

FIG. 12 illustrates the manufacture of an array of masking tapes of the type shown in FIG. 9. Two sheets 60, 61 of suitable foam material are passed together around a score roller 62. The sheet 60, furthest from the roller 62, already has an integral skin 60A formed on its outer surface, for example by a process as described above with reference to FIG. 4. A set of equispaced rotary knives having blunt edges, of which only two 63, 64 are shown, is mounted on a bearing shaft (not shown) located to one side of the score roller 62 and is resiliently-biased towards the score roller with sufficient force to effect a set of parallel, equispaced “cold welds” 67 in the intervening foam sheets 60, 61 without actually cutting through the sheets.

On the opposite side of the score roller 62, pressure-sensitive hot melt adhesive (not shown) is applied in a series of parallel stripes from a die (not shown) onto the outer, skinned, surface of the foam layer 60, between and in accurate alignment with, each pair of adjacent welds 67. The foam material, which now has the form of an array 65 of parallel foam strips 66 joined to one another by welds 67 as shown in FIG. 13, is taken up and wound into a roll either on itself or on a core. As described above with reference to FIG. 7, the ends of the foam strips 66 in the array can, if desired, be temporarily secured for packaging purposes by, for example, adhesive tabs (as described in EP-A-0 384 626), elastic ties (as described in WO 2005/110905), or staples. When required, any of the foam strips 66 can be separated for the desired length from the array 65 by tearing along the welds 67 that join it to adjacent strips: the separated foam strip has the form of the foam tape 40 shown in FIG. 9 and can be used, for example as described above with reference to FIGS. 11A and 11B, to mask a gap between two parts of a vehicle.

It will be appreciated that the width of foam tapes produced as described with reference to FIG. 12 can be adjusted by changing the distance between the rotary knives 63, 64, and that the position of the adhesive stripe on each tape can be adjusted by changing the positions of the die orifices relative to the rotary knives.

In a modification of the process described above with reference to FIG. 12, the sheet 61 (rather than the sheet 60) has an integral skin, in this case on the surface adjacent the score roller 62. The process will then result in an array of foam tapes in which the adhesive stripe is located on the unskinned part of the tape. In a further modification, both sheets 60, 61 have an integral skin, resulting in an array of foam tapes each of the type shown in FIG. 14, having an integral skin 68 over its entire surface.

Particular examples of foam tapes of the type shown in FIGS. 9 and 14, which have been found suitable for use in masking gaps in cars, have been made as described above with reference to FIG. 12 using, for the skinned foam, sheets having a nominal thickness of 3.5 mm formed from polyurethane foam having a nominal density of 28 kg/m³ and, for the unskinned foam, sheets having a nominal thickness of 3 mm formed from polyurethane foam having a nominal density of 26 kg/m³ (both available from Caligen Foams Limited, Broad Oak, Accrington, UK). The tapes were produced in widths (i.e. the distance between the welds 67 in FIG. 12) of 22 mm.

Foam masking tapes of the general type described above with reference to FIGS. 9 to 14 are also described in our co-pending UK patent applications No. 0622340.8 of 9 Nov. 2006, and No. 0711124.8 of the same date as the present application.

It will be appreciated that any suitable thermoplastic, cold-weldable foam material could be used to produce foam tapes by the processes described above with reference to FIGS. 5 and 12. Suitable materials can be found not only among polyurethane foams but also among, for example, polyester, polystyrene, polyvinylchloride, polyethylene, and polypropylene foams. The foam can be open cell or closed cell provided it is sufficiently resiliently compressible for conforming to a required shape for a given application. The density of the foam should be selected to ensure that cold welds of adequate strength can be achieved: foams having a density in the range of from about 20 to about 30 kg m⁻³ are generally useful, although materials with a density outside that range can be employed where appropriate.

The pressure-sensitive adhesive 5, 48 on the foam tapes should be capable of adhering to the foam material, and to the bodywork of a vehicle. When the foam tapes are packaged in the form of a roll, the surface of the tape opposite the adhesive 5, 48 may be coated with a release material to prevent the adhesive on the tapes in one layer of the roll adhering to the tapes in an adjacent layer of the roll. Any suitable release material may be used for this purpose.

Although the welding process described above with reference to FIGS. 5 and 12 provides an efficient method of making foam masking tapes as described above with reference to FIGS. 1, 8, 9 and 14, any other suitable manufacturing process can be used. For example, the welded seams could be formed by a process requiring the input of heat or ultrasonic energy. Alternatively, the foam could be shaped in other ways not involving the formation of welded seams, for example through the use of adhesives, or by cutting, or by heat shaping. For example, a foam tape of the general type shown in FIG. 9 could be formed by joining the two layers of material 41, 42 together face-to-face along their longitudinal edges by and adhesive, or by using adhesive tape (such as double-sided adhesive tape or transfer tape). In those cases, foam materials that are not cold-weldable can be selected.

In some cases, the integral skin on the foam may be formed as part of the shaping process, eliminating the need for a skinned foam as the starting material.

The attachment of a masking article in accordance with the invention to a vehicle may be achieved in any suitable way and is not restricted to the use of a pressure-sensitive adhesive as described above. For example, as an alternative, the article could be attached by magnetic attraction e.g. using a thin magnetic strip embedded in part of the masking article. Whatever form of attachment is used, it should permit flexing of the masking article whilst being secure enough, when the article is used between two-relatively-movable parts of a vehicle, to withstand the pressure wave created by closing a movable part of the vehicle onto it. The attachment means should also be able to withstand any post-treatment of the applied paint (e.g. baking). The attachment point is preferably positioned on a flat region of the surface of the masking article, and preferably away from the longitudinal edge of the masking article that will be pushed by the action of closing parts of the vehicle together. In the case in which an adhesive is used to attach the masking article to the surface of a car, such a location makes it possible to ensure that the adhesive is not exposed by the action of closing parts of the vehicle together, thereby eliminating the risk of a hard edge being created where paint accumulates against the edge of the adhesive. However, the location of the attachment point is a matter of choice and should be selected having regard to the intended use of the masking article.

The foam tapes can be produced with any dimensions suitable for masking surfaces of vehicles in preparation for painting. The presence of the integral skin should not have a detrimental effect on the ability of a foam tape to be placed around curves and corners on a surface to be masked, and to conform to the gaps between two relatively-movable parts of vehicles.

Although the foam tapes described above with reference to FIGS. 1, 8, 9 and 14, are of a particular type having a generally circular or elliptical cross-section, many other forms of foam tape have been proposed for use in masking surfaces of vehicles in preparation for painting (see, for example, the foam tapes described in EP-A-0 669 197 and EP 0 745 000 B1; U.S. Pat. No. 6,337,127 B1 and U.S. Pat. No. 6,627,259 B1; and WO 02/068556 A2 and WO03/020438 A2). It will be appreciated that the advantages achieved through the use of foam materials having an integral skin, as described above, are not restricted to foam tapes having generally circular or elliptical cross-sections and could be achieved with foam tapes of other shapes, particularly if the skinned surface (or at least a part thereof) can be positioned to face towards the direction from which paint will be applied.

### EXAMPLES

The following Examples are provided illustrate the invention. In the Examples, the following materials were used:

Foam A: Polyurethane open-cell foam having a nominal density of 26 kg m⁻³, available from Caligen Foams Limited.
Foam B: Polyurethane open-cell foam having a nominal density of 28 kg m⁻³ and with an integral skin on one side, available with a nominal thickness of 3.5 mm from Caligen Foams Limited.

Using these materials, foam tapes samples were prepared as follows:

Sample 1: A web of Foam A having a thickness of 16 mm was skinned equally on both sides by applying heat and pressure to reduce the thickness to 14 mm. Foam tape of the type illustrated in FIG. 8 was prepared from the skinned foam as described above with reference to FIG. 5, with a distance of 14 mm between adjacent rotary knives.
Sample 2: The method of preparing Sample 1 was repeated, starting with a web of Foam A having a thickness of 18 mm, which was skinned equally on both sides by applying heat and pressure to reduce the thickness to 14 mm.
Sample 3: The method of preparing Sample 1 was repeated, starting with a web of Foam A having a thickness of 20 mm, which was skinned equally on both sides by applying heat and pressure to reduce the thickness to 14 mm.
Comparative sample: Foam tape was prepared by applying the method described above with reference to FIG. 5 to a web of Foam A having a thickness of 14 mm, with a distance of 14 mm between the cold welds.
Sample 4: A web of Foam A having a thickness of 3 mm, and a web of Foam B were used to prepare foam tape of the type illustrated in FIG. 9 by a process as described above with reference to FIG. 12 with a distance of 22 mm between adjacent rotary knives. The adhesive stripe was 5 mm wide and was positioned 6 mm from one of the cold welds.
Sample 5: The method of preparing Sample 4 was repeated except that the webs were inverted so that the adhesive stripe was applied to the (unskinned) surface of Foam A instead of the (skinned) surface of Foam B.

The foam tape samples were assessed as follows:

Lengths of Samples 1 to 3 and the comparative sample were adhered to the frame of a car door in such a position that, when the door was closed onto the tape, the tape was approximately flush with the outer surface of the door and the frame. The outer surface of the door and frame were then coated with “Nexa 6690 Clear Coat” spray paint (available from MaxMeyer UK, Needham Road, Stowmarket, Suffolk, IP14 2AD, UK) applied in conventional manner from a paint spray gun. The edges of the coated region on the door and the frame were examined to assess their quality (specifically their visual appearance and smoothness to the touch). It was found that all samples produced an acceptable soft, smooth, feathered paint edge but that the paint edges produced by Samples 1 to 3 had a markedly improved (less fuzzy) appearance over that produced by a length of the comparative sample, due to a substantial reduction in the number and size of paint speckles associated with the paint edge.

Samples 4 and 5 were assessed in various car repairs as follows:

Repair 1 A dent in the offside front wing of a BMW 320d car was pushed back out and the panel beaten, followed by filler application to reshape the wheel arch and subsequent painting. A length of Sample 5 was applied along a swage line on the lower portion of bumper during the clear coat stage of respraying only, with the skinned surface of the foam tape positioned in the line of sight of the paint spray. A skilled car repairer was able to achieve a paint edge along the swage line that, for non-hardness and non-fuzziness, was rated at 8 out of 10 (where a length of the comparative sample provided paint edges rated at 5 out of 10).
Repair 2 A BMW X5 car bonnet was resprayed. In preparation for this, the bumper was removed, and a length of Sample 4 was applied to the edge of the bonnet, with the adhesive towards the top. The bonnet was then closed so that the foam tape was positioned in the gap between the bonnet and the surround with the skinned surface of the tape positioned in the line of sight of the paint spray. A skilled car repairer was able to achieve a paint edge that, for non-hardness and non-fuzziness, was rated at 7 out of 10 (where a length of the comparative sample provided paint edges rated at 5 out of 10).
Repair 3 In preparation for respraying, a length of Sample 4 was applied to the panel adjacent the nearside of the tailgate of a Volkswagen Beetle car. The tailgate was then closed so that the foam tape was positioned in the gap between the tailgate and the panel, and paint was applied. A front door was removed, and the gap covered with film secured with paper masking tape. A length of Sample 4 was applied around the edge of the film to the A-post and the top curved part of the door frame, and paint was applied. In each case, the foam tape was positioned with the skinned surface of the tape positioned in the line of sight of the paint spray. A skilled car repairer was able to achieve a paint edge that, for non-hardness and non-fuzziness, was rated at 8 out of 10 for the panel adjacent the tailgate, 7 out of 10 for the curved part of the door frame, and 9 out of 10 for the A-post (where a length of the comparative sample provided paint edges rated at 5 out of 10).

1. An elongate masking article that can be removably-attached to a vehicle for masking a surface to be painted, the article being formed from polymeric foam which, on the external surface of the article, or at least a lengthwise-extending part of the article, comprises an integral skin wherein, when the article is attached to a vehicle for masking a surface to be painted, at least a part of the skin will face generally towards the direction from which paint will be applied and the portion of the external surface of the article on which the said part of the skin is located is curved.

2. (canceled)

3. (canceled)

4. A masking article according to claims 1, in which the article comprises a curved external surface maintained by at least one welded scam that extends along the length of the article.

5. A masking article according to claim 2, comprising a pair of lengthwise-extending welded seams on opposite sides of the article, the integral skin extending between the welded seams on at least one part of the article.

6. A masking article according to claim 3, comprising two layers of polymer foam that are arranged face-to-face and joined to one another along their edges by the welded seams.

7. A masking article according to claim 1, in which pressure-sensitive adhesive is provided on the external surface of the article for removably-attaching the article to a part of a vehicle.

8. A masking article according to claim 5, in which the adhesive is in the form of a stripe extending along the length of the article.

9. A masking article according to claim 5, comprising a release coating on the external surface of the article, opposite the adhesive, to prevent the article adhering to itself when wound in a roll.

10. A method of producing a masking article according to claim 3, including the steps of providing a web of polymeric foam having an integral skin over at least one of its major surfaces, and compressing and welding the foam along a pair of parallel lines to form the curved surface.

11. A method of producing an article according to claim 4, including the steps of providing two webs of polymeric foam, at least one of which has an integral skin over at least one of its surfaces, positioning the webs face-to-face with the skin lacing outwards, and compressing and welding the two webs together along a pair of spaced parallel lines.

12. A method according to claim 8, including the step of forming the said integral skin on a web of polymeric foam by applying heat and pressure to at least one major surface of the web to reduce its thickness.

13. A method of producing a masking article according to claim 1, including the step of applying heat and pressure to a surface of the polymeric foam to form the integral skin.

14. A method as claimed in claim 11, in which the integral skin is formed on the polymeric foam before the masking article is formed from the polymeric foam.

15. A method of using an article according to claim 1 for masking a swage line on a vehicle in preparation for spray-painting, the method comprising the step of attaching the article to the surface of the vehicle so that it extends along the swage line with at least a part of the skin facing generally towards the direction from which paint will be applied.

16. A method of using an article according to claim 1 for masking a gap between two relatively-movable parts of a vehicle in preparation for spray-painting, the method comprising the steps of attaching the article to one of the parts, and then bringing the parts together with the article positioned in the gap between them so that at least a part of the skin faces generally towards the direction from which paint will be applied.

17. A method of using an article according to claim 1 for blending newly-applied paint on part of a surface of a vehicle into existing paint on the surface, the method comprising the step of attaching the article to the surface adjacent to the said part thereof with at least part of the skin facing generally towards the direction from which paint will be applied.
